(19) United States
(12) Patent Application Publication
(10) Pub. No.: US 2026/0163925 A1
(43) Pub. Date: Jun. 11, 2026

(54) DATA PACKET TRANSMISSION METHOD AND VIRTUAL NETWORK GROUP

(71) Applicant: CHINA TELECOM CORPORATION LIMITED, Beijing (CN)

(72) Inventors: Yue SUN, Beijing (CN); Hai LIU, Beijing (CN); Biao LONG, Beijing (CN)

(21) Appl. No.: 18/879,857

(22) PCT Filed: Jul. 18, 2023
(86) PCT No.: PCT/CN2023/107979

§ 371 Date: Dec. 30, 2024

(30) Foreign Application Priority Data
Jul. 18, 2022 (CN) 202210842405.4

(51) Int. Cl. H04L 65/1069; H04L 41/40

(52) U.S. Cl. CPC H04L 65/1069; H04L 41/40

(57) ABSTRACT

Embodiments of the present disclosure provide a data packet transmission method and a virtual network group. The solution is as follows: when receiving a first data packet sent by a first UE, a first UPF forwards the first data packet to a first group communication UPF according to a first forwarding rule issued by a first SMF; the first group communication UPF sends the first data packet to a second group communication UPF by using a first communication tunnel according to a destination address in the received first data packet; the second group communication UPF forwards the received first data packet to a second UPF according to a second forwarding rule issued by a second SMF; and the second UPF sends the received first data packet to a second UE. According to the technical solution provided by the embodiments of the present disclosure, multiple SMFs are deployed in virtual networks, so that cross-SMF communication is realized.

The present application is a U.S. National Stage of International Application No. PCT/CN 2023/107979, filed on Jul. 18, 2023, which is based on and claims priority to the Chinese Patent Application NO. 202210842405.4, entitled “DATA PACKET TRANSMISSION METHOD AND VIRTUAL NETWORK GROUP”, filed on Jul. 18, 2022, the entire contents of both of which are hereby incorporated by reference.

### TECHNICAL FIELD

The present disclosure relates to the field of mobile communication technologies, and in particular to a method for transmitting a data packet and a virtual network group.

### BACKGROUND

5th Generation Mobile Communication Technology Local Area Network (5G LAN) can provide users with a virtual data network, and a group of terminals that have signed the same slice and Data Network Name (DNN) is designated as a 5G Virtual Network (VN) group, terminals in the 5G VN group can communicate with each other.

### SUMMARY

Embodiments of the present disclosure provide a method for transmitting a data packet, which is applied to a virtual network group, wherein the virtual network group includes a first Session Management Function (SMF) and a second SMF, the first SMF manages a first User Plane Function (UPF) and a first group communication UPF, and the second SMF manages a second UPF and a second group communication UPF; a first communication tunnel is pre-configured between the first group communication UPF and the second group communication UPF; the first UPF is associated with a first User Equipment (UE), and the second UPF is associated with a second UE; and the method includes: when receiving a first data packet sent by the first UE, forwarding, by the first UPF, the first data packet to the first group communication UPF according to a first forwarding rule issued by the first SMF; sending, by the first group communication UPF, according to a destination address in the received first data packet, the first data packet to the second group communication UPF using the first communication tunnel; forwarding, by the second group communication UPF, the received first data packet to the second UPF according to a second forwarding rule issued by the second SMF; and sending, by the second UPF, the received first data packet to the second UE.

Embodiments of the present disclosure further provide a method for transmitting a data packet, which is applied to a virtual network group, wherein the virtual network group includes a first SMF and a second SMF, the first SMF manages a first group communication UPF, and the second SMF manages a second group communication UPF; a first communication tunnel is pre-configured between the first group communication UPF and the second group communication UPF; the first group communication UPF is associated with a third UE, and the second group communication UPF is associated with a fourth UE; and the method includes: when receiving a second data packet sent by the third UE, sending, by the first group communication UPF, according to a destination address in the received second data packet, the second data packet to the second group communication UPF using the first communication tunnel; and sending, by the second group communication UPF, the received second data packet to the fourth UE.

Embodiments of the present disclosure further provide a virtual network group, which includes a first SMF and a second SMF, the first SMF manages a first UPF and a first group communication UPF, the second SMF manages a second UPF and a second group communication UPF, a first communication tunnel is pre-configured between the first group communication UPF and the second group communication UPF, the first UPF is associated with a first UE, and the second UPF is associated with a second UE; the first UE is configured to send a first data packet to the first UPF; the first UPF is configured to, when receiving the first data packet sent by the first UE, forward the first data packet to the first group communication UPF according to a first forwarding rule issued by the first SMF; the first group communication UPF is configured to send, according to a destination address in the received first data packet, the first data packet to the second group communication UPF using the first communication tunnel; the second group communication UPF is configured to forward the received first data packet to the second UPF according to a second forwarding rule issued by the second SMF; the second UPF is configured to send the received first data packet to the second UE; and the second UE is configured to receive the first data packet.

Embodiments of the present disclosure further provide a virtual network group, wherein the virtual network group includes a first SMF and a second SMF, the first SMF manages a first group communication UPF, the second SMF manages a second group communication UPF, a first communication tunnel is pre-configured between the first group communication UPF and the second group communication UPF, the first group communication UPF is associated with a third UE, and the second group communication UPF is associated with a fourth UE; the third UE is configured to send a second data packet to the first group communication UPF; the first group communication UPF is configured to, when receiving a second data packet sent by the third UE, send, according to a destination address in the received second data packet, the second data packet to the second group communication UPF using the first communication tunnel; the second group communication UPF is configured to send the received second data packet to the fourth UE; and the fourth UE is configured to receive the second data packet.

Embodiments of the present disclosure further provide a physical device, which is any of a SMF, a UPF, a group communication UPF or a UE included in a virtual network group, wherein the physical device includes a processor, a communication interface, a memory, and a communication bus; the processor, the communication interface, and the memory communicate with each other through the communication bus; the memory is configured to store a computer program; and the processor is configured to, when executing the program stored in the memory, implement steps of any of the method for transmitting the data packet as described above.

Embodiments of the present disclosure further provide a computer-readable storage medium having a computer program stored thereon, which, when executed by a processor, implements steps of any of the method for transmitting the data packet as described above.

Embodiments of the present disclosure further provide a computer program product including instructions which, when running on a computer, cause the computer to perform any of the method for transmitting the data packet as described above.

### BRIEF DESCRIPTION OF THE DRAWINGS

In order to more clearly illustrate the technical solutions in the embodiments of the present disclosure or in the related art, the accompany drawings required in the description of the embodiments or the related art will be briefly described below. Obviously, the drawings in the following description are merely some embodiments of the present disclosure; and for those of ordinary skill in the art, other embodiments may be obtained according to these drawings.

FIG. 1A is a first schematic structural diagram of a 5G VN group in the related art.

FIG. 1B is a second schematic structural diagram of a 5G VN group in the related art.

FIG. 2 is a first signaling diagram of a method for transmitting a data packet provided in an embodiment of the present disclosure.

FIG. 3 is a first schematic structural diagram of a virtual network group provided in an embodiment of the present disclosure.

FIG. 4 is a second signaling diagram of a method for transmitting a data packet provided in an embodiment of the present disclosure.

FIG. 5 is a third signaling diagram of a method for transmitting a data packet provided in an embodiment of the present disclosure.

FIG. 6 is a fourth signaling diagram of a method for transmitting a data packet provided in an embodiment of the present disclosure.

FIG. 7 is a fifth signaling diagram of a method for transmitting a data packet provided in an embodiment of the present disclosure.

FIG. 8 is a second schematic structural diagram of a virtual network group provided in an embodiment of the present disclosure.

FIG. 9 is a third schematic structural diagram of a virtual network group provided in an embodiment of the present disclosure.

FIG. 10 is a schematic structural diagram of a physical device provided in an embodiment of the present disclosure.

### DETAILED DESCRIPTION

The technical solutions in the embodiments of the present disclosure will be clearly and completely described below with reference to the accompanying drawings in the embodiments of the present disclosure. Obviously, the described embodiments are only a part of the embodiments of the present disclosure, not all the embodiments of the present disclosure. All other embodiments, obtained by those of ordinary skill in the art based on the embodiments in the present disclosure, fall within the protection scope of the present disclosure.

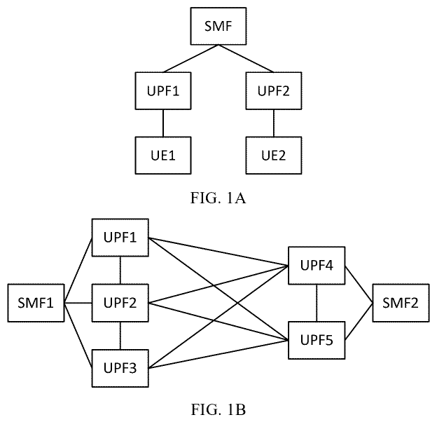

As shown in FIG. 1A, FIG. 1A is a first schematic structural diagram of a 5G VN group in the related art. The 5G VN group shown in FIG. 1A includes one SMF, which manages two UPFs, that is, UPF1 and UPF2 in FIG. 1A, and UPF1 and UPF2 are respectively associated with corresponding UEs, that is, UE1 and UE2 shown in FIG. 1A. UE1 and UE2 can communicate by means of data packet transmission. For example, when UEl sends a data packet to UE2, UE1 can send the data packet to UPF1. In this case, SMF can establish an N19 tunnel between UPF1 and UPF2, and UPF1 can transmit the data packet to UPF2 through the N19 tunnel, so as to transmit the data packet from UPF2 to UE2, thereby realizing communication between UE1 and UE2.

Since the above 5G VN group only includes one SMF, UEs in different 5G VN groups cannot transmit data packets, that is, different SMFs cannot achieve cross-SMF communication. Therefore, in order to solve this problem, a method as shown in FIG. 1B is provided in the related art to achieve the cross-SMF communication. FIG. 1B is a second schematic structural diagram of a 5G VN group in the related art.

In the 5G VN group shown in FIG. 1B, a plurality of SMFs may be included, such as SMF1 and SMF2 shown in FIG. 1B. In order to realize the cross-SMF communication process, it is necessary to configure N19 tunnels between all UPFs managed by different SMFs, for example, UPF1, UPF2, and UPF3 respectively establish N19 tunnels with UPF4 and UPF5 in FIG. 1B.

In the 5G VN group shown in FIG. 1B, UPFs managed by different SMFs need to establish mesh connections in pairs. As the number of UPFs and the number of SMFs in the 5G VN group increase, the number of mesh connections between UPFs managed by different SMFs will greatly increase, which significantly increases the complexity of the network.

In order to solve the problems in the related art, an objective of embodiments of the present disclosure is to provide a method for transmitting a data packet and a virtual network group to deploy a plurality of SMFs in a virtual network, thereby realizing communication across SMFs.

Embodiments of the present disclosure provide a method for transmitting a data packet, which is applied to a virtual network group. The virtual network group includes a first SMF and a second SMF, the first SMF manages a first UPF and a first group communication UPF, and the second SMF manages a second UPF and a second group communication UPF. A first communication tunnel is pre-configured between the first group communication UPF and the second group communication UPF. The first UPF is associated with a first UE, and the second UPF is associated with a second UE.

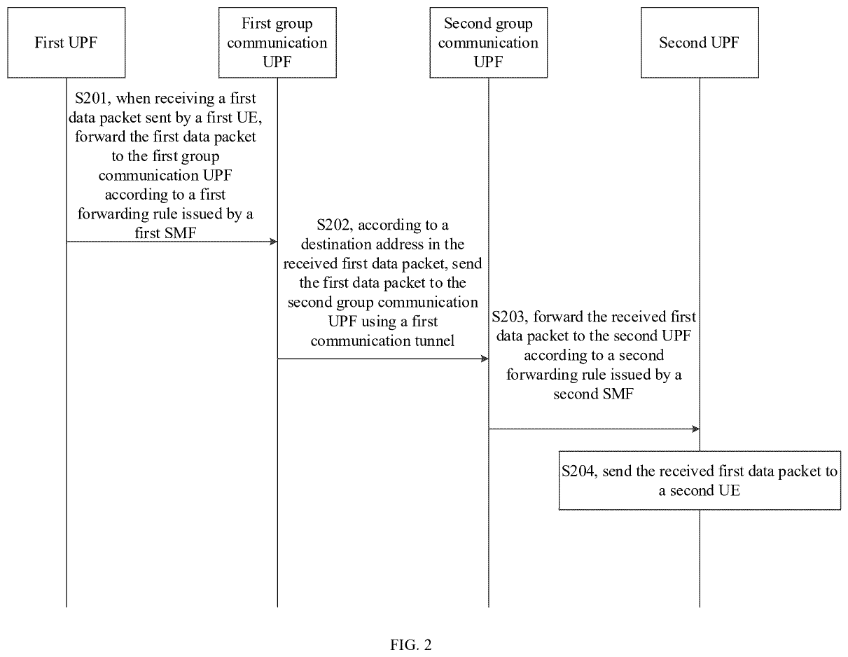

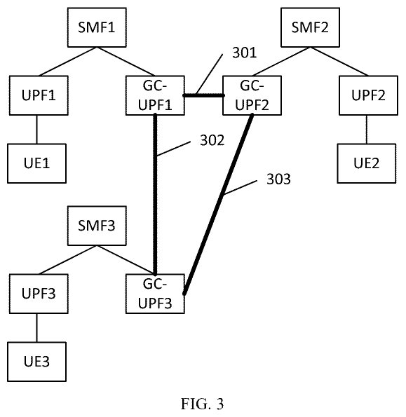

As shown in FIG. 2, FIG. 2 is a first signaling diagram of a method for transmitting a data packet provided in an embodiment of the present disclosure. The method includes the following steps S201 to S204.

In the step S201, when the first UPF receives a first data packet sent by the first UE, the first UPF forwards the first data packet to the first group communication UPF according to a first forwarding rule issued by the first SMF.

In the step S202, according to a destination address in the received first data packet, the first group communication UPF sends the first data packet to the second group communication UPF using the first communication tunnel.

In the step S203, the second group communication UPF forwards the received first data packet to the second UPF according to a second forwarding rule issued by the second SMF.

In the step S204, the second UPF sends the received first data packet to the second UE.

For ease of understanding, as shown in FIG. 3, FIG. 3 is a first schematic structural diagram of a virtual network group provided in an embodiment of the present disclosure. The virtual network group shown in FIG. 3 includes a plurality of SMFs, that is SMF1, SMF2 and SMF3 shown in FIG. 3. Each SMF manages at least one UPF. For example, the UPF managed by SMF1 in FIG. 3 includes: UPF1 and GC-UPF1, where GC-UPF1 is a Group Communication-User Plane Function (i.e., the above group communication UPF, denoted as GC-UPF) managed by SMF1. The UE can be associated with the UPF by accessing a Radio Access Network (RAN, not shown in FIG. 3) within a range of SMF. For example, UE1 shown in FIG. 3 is associated with UPF1 by accessing the RAN within the range of SMF.

In the virtual network group shown in FIG. 3, a communication tunnel, such as N19 and/or N6 tunnels, may be pre-configured between GC-UPFs managed by different SMFs. For example, in FIG. 3, tunnel 301 is pre-configured between GC-UPF1 and GC-UPF2, tunnel 302 is pre-configured between GC-UPF1 and GC-UPF3, and tunnel 303 is pre-configured between GC-UPF2 and GC-UPF3.

In embodiments of the present disclosure, the virtual network group may include the plurality of SMFs, each SMF may manage a plurality of UPFs, and each UPF may be associated with a plurality of UEs. Here, the number of SMFs, the number of UPFs, and the number of UEs in the virtual network group are not specifically limited. For ease of understanding, the following only takes two SMFs in the virtual network group, one UPF and one GC-UPF managed by each SMF, and one UE associated with the UPF as an example for explanation, which does not serve as any limitation.

In the above virtual network group, the SMF, the UPF, the GC-UPF and the UE are all physical devices. The number of GC-UPFs among the UPFs managed by each SMF is one.

Through the method shown in FIG. 2, when the first UPF managed by the first SMF in the virtual network group receives the first data packet sent by its associated first UE, the first UPF can forward the first data packet to the first group communication UPF managed by the first SMF. The first group communication UPF, based on the destination address in the received first data packet, sends the first data packet to the second group communication UPF using the first communication tunnel pre-configured between the first group communication UPF and the second group communication UPF managed by the second SMF, so that the second group communication UPF can forward the first data packet to the second UE through the second UPF managed by the second SMF.

The plurality of SMFs can be deployed in the virtual network group. For every two SMFs, the data packet transmission process between UEs in different SMFs can be realized through the pre-configured communication tunnel between the group communication UPFs of these two SMFs. This makes it possible to realize data packet transmission between different SMFs while deploying the plurality of SMFs in the virtual network, that is, the communication across SMFs is realized.

Furthermore, since there is only one group communication UPF among the UPFs managed by each SMF, the communication between individual SMFs in the virtual network group only relies on the communication tunnels between the group communication UPFs managed by themselves, which greatly reduces the network complexity of the virtual network group.

Please note that it is not necessary for any product or method of the present disclosure to achieve all the advantages described above.

With respect to the above step S201, when the first UPF receives the first data packet sent by the first UE, the first UPF forwards the first data packet to the first group communication UPF according to the first forwarding rule issued by the first SMF.

The first UE in the above virtual network group can initiate communication with the second UE in this virtual network group, that is, the first UE establishes a Protocol Data Unit (PDU) session. In this case, the first UE will send the first data packet to the first UPF associated with it. The first UPF will receive the first data packet sent by the first UE.

Depending on specific needs of users corresponding to the first UE and the second UE, the first data packet may be a data request data packet for requesting certain data, or a data transmission data packet for transmitting certain data. Here, the first data packet is not specifically limited.

When the first UE sends the first data packet to the first UPF, the first SMF may send, according to the first data packet, a forwarding rule (referred to as the first forwarding rule) for the first data packet to the first UPF. The first forwarding rule may include port information, address information, etc. of the first group communication UPF. After receiving the first forwarding rule, the first UPF may forward the first data packet to the first group communication UPF according to the first forwarding rule. Here, information included in the first forwarding rule is not specifically limited.

With respect to the above step S202, according to the destination address in the received first data packet, the first group communication UPF sends the first data packet to the second group communication UPF using the first communication tunnel.

In this step, the first data packet includes at least triplet information, that is, a source address, a destination address and a transport layer protocol. After receiving the first data packet sent by the first UPF, the first group communication UPF can determine, according to the destination address in the first data packet, the group communication UPF (i.e., the second group communication UPF, that is, a group communication UPF managed by a SMF where a UPF associated with the second UE is located) that receives the first data packet. The first group communication UPF can use the first communication tunnel between it and the second group communication UPF to send the received first data packet to the second group communication UPF.

In some embodiments, the above step S202 of sending, according to the destination address in the received first data packet, the first data packet to the second group communication UPF using the first communication tunnel can be expressed as:
based on a forwarding table between individual group communication UPFs, sending, according to the destination address in the received first data packet, the first data packet to the second group communication UPF using the first communication tunnel.

In embodiments of the present disclosure, after the deployment of the virtual network group is completed, the forwarding table between individual group communication UPFs can be configured according to the UPFs managed by individual SMFs and the UEs associated with individual UPFs. After the first group communication UPF receives the first data packet, since the first data packet is a data packet sent by the first UE to the second UE, the destination address in the first data packet is an address corresponding to the second UE. In this case, the first group communication UPF can determine in the forwarding table, according to the destination address, an output interface or the next hop corresponding to the first data packet, thereby determining the second group communication UPF to which the first data packet needs to be forwarded. The first group communication UPF can use the first communication tunnel pre-configured between it and the second group communication UPF to forward the first data packet to the second group communication UPF.

The destination address may be a Media Access Control (MAC) address or an Internet Protocol (IP) address of the second UE. Here, the destination address is not specifically limited.

With respect to the above step S203, the second group communication UPF forwards the received first data packet to the second UPF according to the second forwarding rule issued by the second SMF.

In this step, when the second group communication UPF receives the first data packet, the second SMF can send, according to the destination address of the data packet to be transmitted, a forwarding rule (denoted as the second forwarding rule) for the first data packet to the second group communication UPF. The second forwarding rule may include port information, address information, etc. of the second UPF. The second group communication UPF forwards the first data packet to the second UPF according to the second forwarding rule. Here, information included in the second forwarding rule is not specifically limited.

With respect to the above step S204, the second UPF sends the received first data packet to the second UE.

In this step, after receiving the first data packet sent by the second group communication UPF, the second UPF can send the first data packet to the second UE according to the destination address of the first data packet. In this case, the second UE will receive the first data packet, and the data packet transmission process of the first data packet from the first UE to the second UE is ended, realizing the communication between the first UE and the second UE.

For ease of understanding, the above steps S201 to S204 are described in conjunction with the virtual network group shown in FIG. 3. It is now assumed that the first SMF is SMF1, the first UPF is UPF1, the first UE is UE1, the first group communication UPF is GC-UPF1, the second SMF is SMF2, the second UPF is UPF3, the second UE is UE2, and the second group communication UPF is GC-UPF2.

When UE1 initiates cross-SMF communication with UE2, UE1 sends the first data packet to UPF1. UPF1 forwards the received first data packet to GC-UPF1 according to the forwarding rule issued by SMF1. Based on the destination address of the first data packet, i.e., an address of UE2, GC-UPF1 determines, by looking up the forwarding table, that the GC-UPF managed by SMF2 (i.e., the SMF that manages UPF2 associated with UE2) is GC-UPF2. GC-UPF1 can use tunnel 301 to send the first data packet to GC-UPF2. GC-UPF2 forwards the first data packet to UPF2 according to the forwarding rule issued by SMF2. UPF2 sends the first data packet to UE2 based on the destination address of the first data packet, i.e., the address of UE2.

Compared with the above virtual network group shown in FIG. 1B, the virtual network group shown in FIG. 3 can realize communication across SMFs, and in the virtual network group shown in FIG. 3, since GC-UPF can be any UPF among at least one UPF managed by the SMF, no new network element/functional module is introduced in the UPF shown in FIG. 3. In addition, compared with the above virtual network group shown in FIG. 1B, in the virtual network shown in FIG. 3, only communication tunnels are pre-established between different GC-UPFs, and it is not necessary to establish mesh connections between UPFs managed by individual SMFs. For example, in the virtual network group shown in FIG. 3, it is not necessary to establish mesh connections between UPF1, UPF2 and UPF3. Moreover, as the number of SMFs in the virtual network group increases, it is only necessary to configure the communication tunnels between the GC-UPFs managed by individual SMFs, and the increase in UPFs does not increase new mesh connections. This greatly reduces the deployment cost of the virtual network group and the complexity of the virtual network group, thereby reducing the complexity of the cross-SMF communication process.

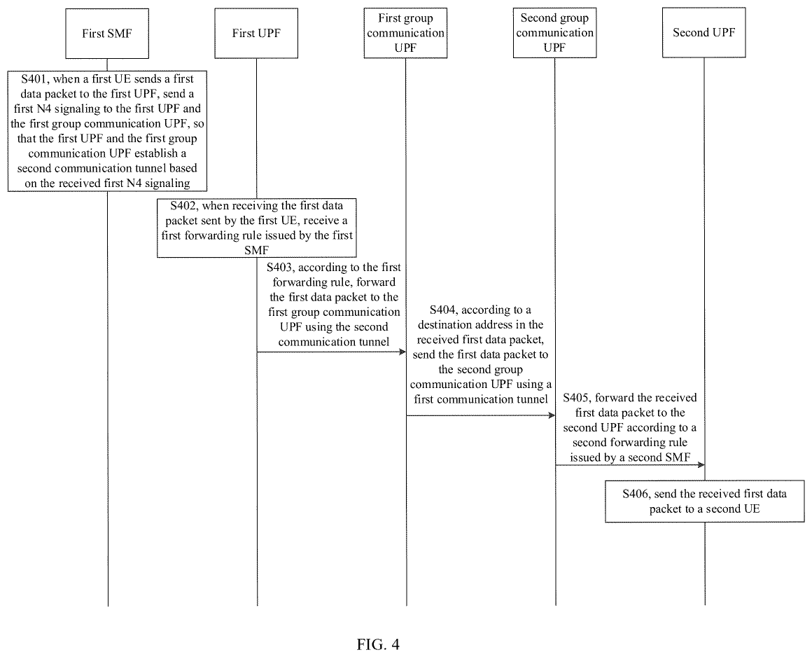

In some embodiments, according to the above method shown in FIG. 2, embodiments of the present disclosure further provide a method for transmitting a data packet. As shown in FIG. 4, FIG. 4 is a second signaling diagram of a method for transmitting a data packet provided in an embodiment of the present disclosure. The method includes the following steps S401 to S406.

In the step S401, when the first UE sends the first data packet to the first UPF, the first SMF sends a first N4 signaling to the first UPF and the first group communication UPF, so that the first UPF and the first group communication UPF establish a second communication tunnel based on the received first N4 signaling.

In this step, when the first UE initiates the communication with the second UE, that is, when the first UE sends the first data packet to the first UPF, the first SMF will monitor establishment of a PDU session for the cross-SMF communication. At this time, the first SMF can issue a N4 signaling (denoted as the first N4 signaling) to the first UPF and the first group communication UPF. The first UPF and the first group communication UPF will establish, based on the first N4 signaling, a communication tunnel between them (denoted as the second communication tunnel), such as the above-mentioned N19 tunnel, or the N9 tunnel.

In the step S402, when receiving the first data packet sent by the first UE, the first UPF receives the first forwarding rule issued by the first SMF.

In the embodiment of the present disclosure, there is no specific limitation on an order of issuing the first N4 signaling and the first forwarding rule.

In the step S403, according to the first forwarding rule, the first UPF forwards the first data packet to the first group communication UPF using the second communication tunnel.

In the above method shown in FIG. 2, the transmission process of the first data packet is only described from the perspective of the user plane. During the transmission process of the first data packet, a control plane also participates in the transmission of the first data packet, that is, the first SMF controls the establishment of the second communication tunnel between the first UPF and the first group communication UPF.

The steps S402 to S403 are implementations of the above step S201 in some embodiments.

In some embodiments, the first SMF may release the second communication tunnel according to a preset release rule to save system resources. For example, the first SMF may release the second communication tunnel after the first UE completes the communication with the second UE. The release of the second communication tunnel and the preset release rule are not specifically limited here.

In an embodiment of the present disclosure, the establishment of the second communication tunnel is based on the UE that sends the first data packet, and is dynamically established in real time between the UPF associated with the UE and the group communication UPF in the same SMF as the UPF associated with the UE, which is not pre-configured like the first communication tunnel, thereby effectively improving the flexibility of establishing the communication tunnel between the UPF and the group communication UPF.

In the step S404, according to the destination address in the received first data packet, the first group communication UPF sends the first data packet to the second group communication UPF using the first communication tunnel.

In the step S405, the second group communication UPF forwards the received first data packet to the second UPF according to the second forwarding rule issued by the second SMF.

In the step S406, the second UPF sends the received first data packet to the second UE.

For specific implementations of the above steps S404 to S406, reference may be made to the specific implementations of the above steps S202 to S204.

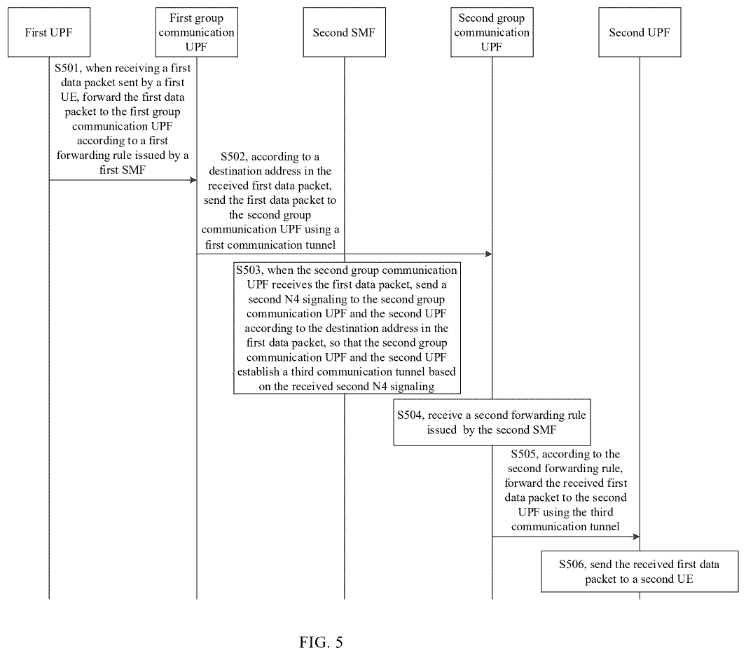

In some embodiments, according to the above method shown in FIG. 2, embodiments of the present disclosure further provide a method for transmitting a data packet. As shown in FIG. 5, FIG. 5 is a third signaling diagram of a method for transmitting a data packet provided in an embodiment of the present disclosure. The method includes the following steps S501 to S506.

In the step S501, when receiving the first data packet sent by the first UE, the first UPF forwards the first data packet to the first group communication UPF according to the first forwarding rule issued by the first SMF.

In the step S502, according to the destination address in the received first data packet, the first group communication UPF sends the first data packet to the second group communication UPF using the first communication tunnel.

For specific implementations of the above steps S501 to S502, reference may be made to the specific implementations of the above steps S201 to S202.

In the step S503, when the second group communication UPF receives the first data packet, the second SMF sends a second N4 signaling to the second group communication UPF and the second UPF according to the destination address in the first data packet, so that the second group communication UPF and the second UPF establish a third communication tunnel based on the received second N4 signaling.

In this step, when the second group communication UPF receives the first data packet sent by the first group communication UPF, the second SMF can determine, according to the destination address of the first data packet, a UPF (that is, the second UPF) associated with the UE corresponding to the destination address. In this case, the second SMF can send a N4 signaling (denoted as the second N4 signaling) to the second group communication UPF and the second UPF. The second group communication UPF and the second UPF establish, based on the received second N4 signaling, a communication tunnel (denoted as the third communication tunnel) therebetween, such as the N19 tunnel, or the N9 tunnel.

In the step S504, the second group communication UPF receives the second forwarding rule sent by the second SMF.

In embodiments of the present disclosure, there is no specific limitation on the order of issuing the second N4 signaling and the second forwarding rule.

In the step S505, according to the second forwarding rule, the second group communication UPF forwards the received first data packet to the second UPF using the third communication tunnel.

In the above method shown in FIG. 2, the transmission process of the first data packet is only described from the perspective of the user plane. During the transmission process of the first data packet, a control plane also participates in the transmission of the first data packet, that is, the second SMF controls the establishment of the third communication tunnel between the second UPF and the second group communication UPF.

The above steps S504 to S505 are implementations of the above step S203 in some embodiments.

In some embodiments, the second SMF may release the third communication tunnel according to the preset release rule to save system resources. For example, the second SMF may release the third communication tunnel after the first UE completes the communication with the second UE. The release of the third communication tunnel and the preset release rule are not specifically limited here.

In the step S506, the second UPF sends the received first data packet to the second UE.

For the specific implementation of the above step S506, reference may be made to the specific implementation of the above step S204.

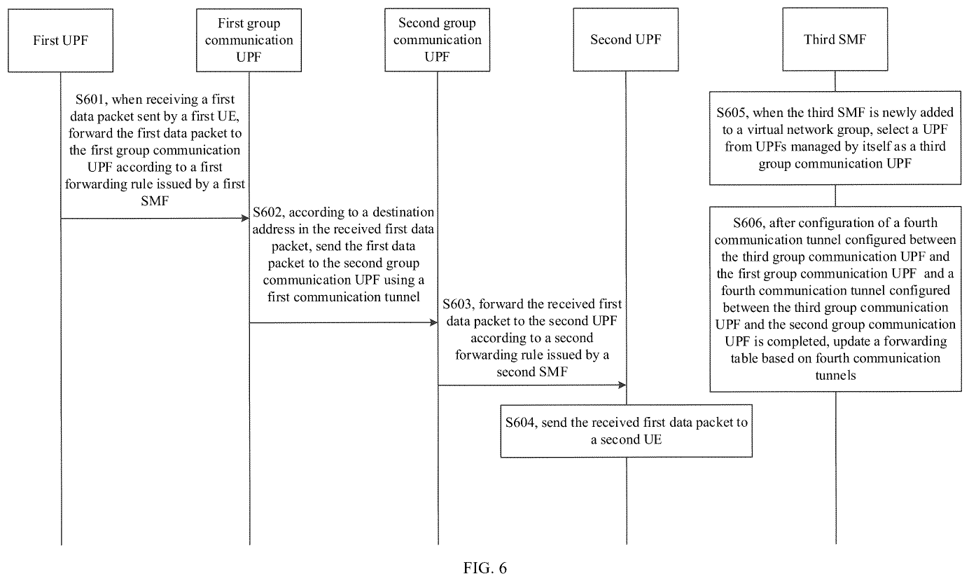

In some embodiments, according to the above method shown in FIG. 2, embodiments of the present disclosure further provide a method for transmitting a data packet. As shown in FIG. 6, FIG. 6 is a fourth signaling diagram of a method for transmitting a data packet provided in an embodiment of the present disclosure. The method includes the following steps S601 to S606.

In the step S601, when the first UPF receives a first data packet sent by the first UE, the first UPF forwards the first data packet to the first group communication UPF according to a first forwarding rule issued by the first SMF.

In the step S602, according to a destination address in the received first data packet, the first group communication UPF sends the first data packet to the second group communication UPF using the first communication tunnel.

In the step S603, the second group communication UPF forwards the received first data packet to the second UPF according to a second forwarding rule issued by the second SMF.

In the step S604, the second UPF sends the received first data packet to the second UE.

The above steps S601 to S604 are the same as the above steps S201 to S204.

In the step S605, when a third SMF is newly added to the virtual network group, the third SMF selects a UPF from UPFs managed by itself as a third group communication UPF.

In embodiments of the present disclosure, the user can add a new SMF (denoted as the third SMF) to the virtual network group according to specific needs. After the third SMF is added to the virtual network group, the third SMF will select a UPF from its associated UPFs as the group communication UPF (denoted as the third group communication UPF).

In some embodiments, when selecting the third group communication UPF, the third SMF may select a UPF that is not associated with a UE as the third group communication UPF.

In some other embodiments, when selecting the third group communication UPF, the third SMF may select a UPF with the highest performance among all UPFs as the third group communication UPF.

In embodiments of the present disclosure, there is no specific limitation on the selection method of the third group communication UPF.

After the third group communication UPF is determined, the user can configure a communication tunnel (denoted as a fourth communication tunnel), such as the N19 and/or N6 tunnels, between the third group communication UPF and other group communication UPFs in the virtual network group (i.e., the first group communication UPF and the second group communication UPF). The configuration process of the fourth tunnel is not described in detail here.

In embodiments of the present disclosure, by adding the new SMF in the above virtual network, the cross-SMF communication between different SMFs can be realized. When different SMFs correspond to different provinces, cities or countries, cross-regional communication between different provinces, cities or countries can be realized by the addition of the new SMF in the virtual network group, thereby reducing the communication cost of the cross-regional communication.

In the step S606, after configuration of a fourth communication tunnel configured between the third group communication UPF and the first group communication and a fourth communication tunnel configured between the third group communication UPF and the second group communication UPF is completed, the third SMF updates the forwarding table based on the fourth communication tunnels.

In this step, when the configuration of the fourth communication tunnel between the third group communication UPF and the first group communication and the fourth communication tunnel between the third group communication UPF and the second group communication UPF is completed, the third SMF can update the forwarding table according to each fourth communication tunnel, two group communication UPFs connected to each fourth communication tunnel and the UE associated with the UPF managed by the same SMF as the group communication UPF.

For ease of understanding, the virtual network group shown in FIG. 3 is still taken as an example for explanation. It is now assumed that the third SMF is SMF3 in FIG. 3. After SMF3 is added to the virtual network group shown in FIG. 3, tunnels 302 and 303 shown in FIG. 3 can be configured. In addition, SMF3 can update the forwarding table according to each UPF managed by SMF1, SMF2 and SMF3 corresponding to GC-UPF1, GC-UPF2, GC-UPF3 connected to tunnels 302 and 303 and the UE associated with each UPF.

By updating the above forwarding table, the validity and accuracy of the forwarding table can be effectively guaranteed, which facilitates the forwarding of data packets between different GC-UPFs and provides guarantees for communication across SMFs.

In the above embodiments, the update of the forwarding table when the new SMF is added to the virtual network group is only taken as an example for explanation. In addition, when a new UPF is added to the SMF, a new UE is added to the SMF, a UPF associated with a UE is changed, or a certain SMF, UPF or UE is deleted, the forwarding table will also be updated synchronously. Here, the update timing of the forwarding table is not specifically limited.

Compared to the above virtual network group shown in FIG. 1B, in the virtual network group shown in FIG. 3, as the number of SMFs in the virtual network increases, only the communication tunnels between individual GC-UPFs need to be configured in the virtual network group. However, in the virtual network group shown in FIG. 1B, since it is necessary to add new communication tunnels between UPFs managed by different SMFs, the number of newly added communication tunnels will increase with the increase in the number of newly added SMFs and the number of UPFs managed by individual SMFs. That is, in the virtual network group shown in FIG. 3, it is only necessary to configure communication tunnels between individual group communication UPFs, while in the virtual network group shown in FIG. 1B, it is necessary to establish communication tunnels between UPFs managed by individual SMFs. Through the virtual network group provided by embodiments of the present disclosure, by pre-configuring the communication tunnels between individual group communication UPFs, the network complexity of the virtual network group can be effectively reduced while realizing the cross-SMF communication.

In embodiments of the present disclosure, the above steps S605 and S606 may be executed before or after the execution of any of the above steps S601 to S604. Here, the execution of the above steps S605 and S606 is not specifically limited.

Based on the same inventive concept, according to the method for transmitting the data packet provided by the above-mentioned embodiments of the present disclosure, embodiments of the present disclosure further provide a method for transmitting a data packet. The method is applied to a virtual network group, the virtual network group includes a first SMF and a second SMF, the first SMF manages a first group communication UPF, and the second SMF manages a second group communication UPF. A first communication tunnel is pre-configured between the first group communication UPF and the second group communication UPF. The first group communication UPF is associated with a third UE, and the second group communication UPF is associated with a fourth UE. As shown in FIG. 7, FIG. 7 is a fifth signaling diagram of a method for transmitting a data packet provided in an embodiment of the present disclosure. The method includes the following steps S701 to S702.

In the step S701, after receiving a second data packet sent by the third UE, the first group communication UPF sends, according to a destination address in the received second data packet, the second data packet to the second group communication UPF using the first communication tunnel.

In this step, when the third UE initiates communication with the fourth UE, that is, when the third UE sends the second data packet to the fourth UE, the first group communication UPF associated with the third UE will receive the second data packet. In this case, the first group communication UPF can send, according to the destination address in the second data packet, the second data packet to the second group communication UPF using the first communication tunnel.

For the process of the first group communication UPF sending the second data packet, reference may be made to the process of the first group communication UPF sending the first data packet, which will not be described in detail here.

In the step S702, the second group communication UPF sends the received second data packet to the fourth UE.

In this step, after receiving the second data packet, the second group communication UPF may send the second data packet to the fourth UE according to the destination address of the second data packet.

In the method shown in FIG. 7, the plurality of SMFs can be deployed in the virtual network group. For every two SMFs, the data packet transmission process between UEs in different SMFs can be realized through the pre-configured communication tunnel between the group communication UPFs of these two SMFs. This makes it possible to realize data packet transmission between different SMFs while deploying the plurality of SMFs in the virtual network, that is, the communication across SMFs is realized.

Furthermore, since there is only one group communication UPF among the UPFs managed by each SMF, the communication between individual SMFs in the virtual network group only relies on the communication tunnels between the group communication UPFs managed by themselves, which greatly reduces the network complexity of the virtual network group.

In the above embodiments shown in FIG. 2 and FIG. 7, the data packet transmission process between UEs not associated with the group communication UPFs and the data packet transmission process between UEs associated with the group communication UPFs are described, respectively. In addition, a sender/receiver of the data packet can also be a UE not associated with the group communication UPF, and a receiver/sender of the data packet can be a UE associated with the group communication UPF. In this case, for the data packet transmission process, reference may be made to the above method shown in FIG. 2 and FIG. 7, the cross-SMF communication is realized, and the specific transmission process is not described here.

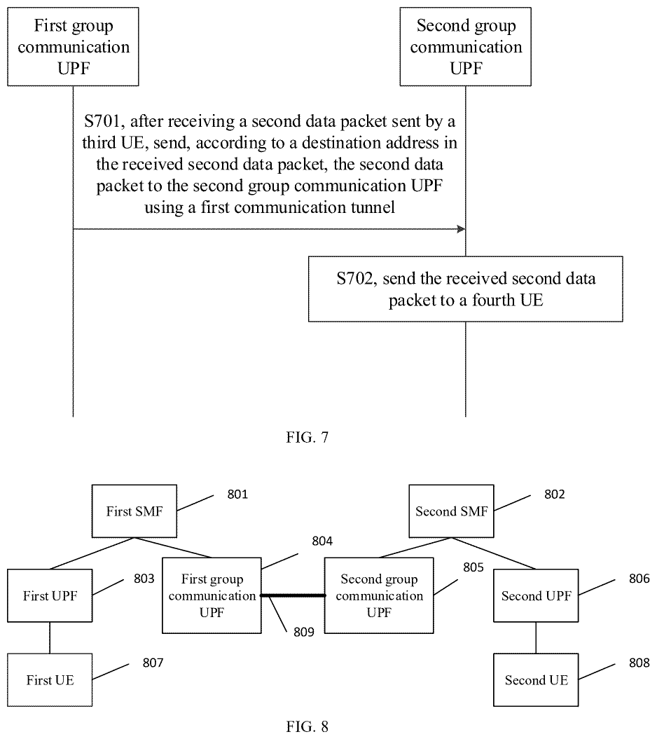

Based on the same inventive concept, according to the method for transmitting the data packet provided by the above embodiments of the present disclosure, embodiments of the present disclosure further provide a virtual network group. As shown in FIG. 8, FIG. 8 is a second schematic structural diagram of a virtual network group provided in an embodiment of the present disclosure. The virtual network group includes a first SMF 801 and a second SMF 802, the first SMF 801 manages a first UPF 803 and a first group communication UPF 804, and the second SMF 802 manages a second UPF 806 and a second group communication UPF 805. A first communication tunnel 809 is pre-configured between the first group communication UPF 804 and the second group communication UPF 805. The first UPF 803 is associated with a first UE 807, and the second UPF 806 is associated with a second UE 808.

The first UE 807 may be configured to send a first data packet to the first UPF 803.

The first UPF 803 may be configured to, when receiving the first data packet sent by the first UE 807, forward the first data packet to the first group communication UPF 804 according to a first forwarding rule issued by the first SMF 801.

The first group communication UPF 804 may be configured to send, according to a destination address in the received first data packet, the first data packet to the second group communication UPF 805 using the first communication tunnel 809.

The second group communication UPF 805 may be configured to forward the received first data packet to the second UPF 806 according to a second forwarding rule issued by the second SMF 802.

The second UPF 806 may be configured to send the received first data packet to the second UE 808.

The second UE 808 may be configured to receive the first data packet.

In some embodiments, the first SMF 801 may be further configured to, when the first data packet is sent to the first UPF 803 by the first UE, send a first N4 signaling to the first UPF 803 and the first group communication UPF 804 to make the first UPF 803 and the first group communication UPF 804 establish, based on the received first N4 signaling, a second communication tunnel.

The first UPF 803 may be further configured to receive the first forwarding rule issued by the first SMF 801; and forward, according to the first forwarding rule, the first data packet to the first group communication UPF 804 using the second communication tunnel.

In some embodiments, the second SMF 802 may be further configured to, when the first data packet is received by the second group communication UPF 805, send a second N4 signaling to the second group communication UPF 805 and the second UPF 806 according to the destination address in the first data packet to make the second group communication UPF 805 and the second UPF 806 establish, based on the received second N4 signaling, a third communication tunnel.

The second group communication UPF 805 may be further configured to receive the second forwarding rule issued by the second SMF 802; and forward, according to the second forwarding rule, the received first data packet to the second UPF 806 using the third communication tunnel.

In some embodiments, the first group communication UPF 804 may be further configured to, based on a forwarding table between individual group communication UPFs, send, according to the destination address in the received first data packet, the first data packet to the second group communication UPF using the first communication tunnel.

The virtual network group may further include: a newly added third SMF.

The third SMF may be configured to select a UPF from UPFs managed by itself as a third group communication UPF.

The third SMF may be further configured to, when configuration of a fourth communication tunnel configured between the third group communication UPF and the first group communication UPF 804 and a fourth communication tunnel configured between the third group communication UPF and the second group communication UPF 805 is completed, update the forwarding table based on fourth communication tunnels.

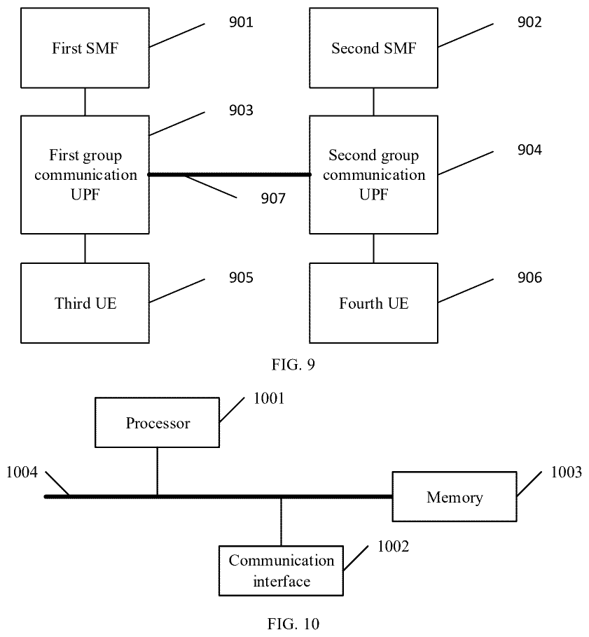

Based on the same inventive concept, according to the method for transmitting the data packet provided by the above-mentioned embodiments of the present disclosure, embodiments of the present disclosure further provide a virtual network group. As shown in FIG. 9, FIG. 9 is a third schematic structural diagram of a virtual network group provided in an embodiment of the present disclosure. The virtual network group includes a first SMF 901 and a second SMF 902, the first SMF 901 manages a first group communication UPF 903, and the second SMF 902 manages a second group communication UPF 904. A first communication tunnel 907 is pre-configured between the first group communication UPF 903 and the second group communication UPF 904. The first group communication UPF 903 is associated with a third UE 905, and the second group communication UPF 904 is associated with a fourth UE 906.

The third UE 905 may be configured to send a second data packet to the first group communication UPF 903.

The first group communication UPF 903 may be configured to, when receiving the second data packet sent by the third UE 905, send, according to a destination address in the received second data packet, the second data packet to the second group communication UPF 904 using the first communication tunnel 907.

The second group communication UPF 904 may be configured to send the received second data packet to the fourth UE 906.

The fourth UE 906 may be configured to receive the second data packet.

Through the virtual network group provided by embodiments of the present disclosure, when the first UPF managed by the first SMF in the virtual network group receives the first data packet sent by its associated first UE, the first UPF can forward the first data packet to the first group communication UPF managed by the first SMF. The first group communication UPF, based on the destination address in the received first data packet, sends the first data packet to the second group communication UPF using the first communication tunnel pre-configured between the first group communication UPF and the second group communication UPF managed by the second SMF, so that the second group communication UPF can forward the first data packet to the second UE through the second UPF managed by the second SMF.

The plurality of SMFs can be deployed in the virtual network group. For every two SMFs, the data packet transmission process between UEs in different SMFs can be realized through the pre-configured communication tunnel between the group communication UPFs of these two SMFs. This makes it possible to realize data packet transmission between different SMFs while deploying the plurality of SMFs in the virtual network, that is, the communication across SMFs is realized.

Furthermore, since there is only one group communication UPF among the UPFs managed by each SMF, the communication between individual SMFs in the virtual network group only relies on the communication tunnels between the group communication UPFs managed by themselves, which greatly reduces the network complexity of the virtual network group.

Based on the same inventive concept, according to the method for transmitting the data packet provided by the above-mentioned embodiments of the present disclosure, embodiments of the present disclosure further provide a physical device, which can be any of a SMF, a UPF, a group communication UPF or a UE included in the virtual network group. As shown in FIG. 10, the physical device includes a processor 1001, a communication interface 1002, a memory 1003 and a communication bus 1004, and the processor 1001, the communication interface 1002, and the memory 1003 communicate with each other through the communication bus 1004.

The memory 1003 may be configured to store a computer program.

The processor 1001 may be configured to implement steps of any of the method for transmitting the data packet when executing the program stored in the memory 1003.

The communication bus 1004 mentioned in the target terminal and the target network device may be a Peripheral Component Interconnect (PCI) bus or an Extended Industry Standard Architecture (EISA) bus, or the like. The communication bus 1004 may be classified into an address bus, a data bus, a control bus, or the like. For ease of representation, only one thick line is used for representation in the figure, but it does not mean that there is only one bus or one type of bus.

The communication interface 1002 may be used for communication between the above-mentioned physical device and other devices.

The memory 1003 may include a random access memory (RAM), or may include a non-volatile memory (NVM), such as, at least one magnetic disk memory. Optionally, the memory may alternatively be at least one storage apparatus located away from the foregoing processor.

The processor 1001 may be a general-purpose processor, including a central processing unit (CPU), a network processor (NP), or the like, or may be a digital signal processor (DSP), an application specific integrated circuit (ASIC), a field-programmable gate array (FPGA), or another programmable logic device, a discrete gate or a transistor logic device, a discrete hardware component.

Based on the same inventive concept, according to the method for transmitting the data packet provided by the above-mentioned embodiments of the present disclosure, embodiments of the present disclosure further provide a computer-readable storage medium having a computer program stored thereon, which, when executed by a processor, implements steps of any of the method for transmitting the data packet as described above.

Based on the same inventive concept, according to the method for transmitting the data packet provided in the above-mentioned embodiments of the present disclosure, embodiments of the present disclosure further provide a computer program product containing instructions, which, when executed on a computer, causes the computer to execute any of the method for transmitting the data packet in the above-mentioned embodiments.

All or some of the foregoing embodiments may be implemented by using software, hardware, firmware, or any combination of them. When software is used to implement the embodiments, all or some of the embodiments may be implemented in a form of a computer program product. The computer program product includes one or more computer instructions. When the computer program instructions are loaded and executed on a computer, the procedures or functions according to the embodiments of the present disclosure are all or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, a computer, a server, or a data center to another website, computer, server, or data center in a wired (e.g., a coaxial cable, an optical fiber, a digital subscriber line (DSL)), or a wireless (e.g., infrared, wireless, microwave, etc.) manner. The computer-readable storage medium may be any usable medium accessible by a computer, or a data storage device, such as a server, a data center, etc., that includes one or more usable medium integrations. The usable medium may be a magnetic medium (for example, a floppy disk, a hard disk, or a magnetic tape), an optical medium (for example, a DVD), a semiconductor medium (for example, a solid state disk (SSD)), or the like.

It should be noted that, in the context, relational terms such as first and second are only used to distinguish one entity or operation from another entity or operation, and do not necessarily require or imply that any such actual relationship or sequence exists between these entities or operations. Moreover, the terms “comprising”, “including” or any other variation of them are intended to cover a non-exclusive inclusion, so that a process, method, article, or device that includes a series of elements not only includes those elements, but also includes other elements that are not explicitly listed, or includes elements inherent to such a process, method, article, or device. In the absence of more restrictions, for the element defined by the statement of “including a . . . ” , it is not excluded that there are additional identical elements in the process, method, article, or device that includes the element.

The various embodiments in the specification are described in a related manner, and the same or similar parts between the embodiments may refer to each other, and each embodiment focuses on a difference from other embodiments. In particular, for the embodiments of the virtual network group, the physical device, the computer-readable storage medium, and the computer program products, etc., since they are substantially similar to the method embodiments, the description is relatively simple, and for the related parts, reference may be made to the description of the method embodiments.

The above are only preferred embodiments of the present disclosure and are not intended to limit the scope of protection of the present disclosure. Any modifications, equivalent replacements, improvements or the like made within the spirit and principle of the present disclosure are all included in the protection scope of the present disclosure.

1. A method for transmitting a data packet, applied to a virtual network group, comprising:
providing or accessing the virtual network group, wherein the virtual network group comprises a first Session Management Function (SMF) and a second SMF, a first User Plane Function (UPF) and a first group communication UPF managed by the first SMF, and a second UPF and a second group communication UPF managed by the second SMF, wherein a first communication tunnel is pre-configured between the first group communication UPF and the second group communication UPF, the first UPF is associated with a first User Equipment (UE), and the second UPF is associated with a second UE;
when receiving a first data packet sent by the first UE, forwarding, by the first UPF, the first data packet to the first group communication UPF according to a first forwarding rule issued by the first SMF;
sending, by the first group communication UPF, according to a destination address in the received first data packet, the first data packet to the second group communication UPF using the first communication tunnel;
forwarding, by the second group communication UPF, the received first data packet to the second UPF according to a second forwarding rule issued by the second SMF; and
sending, by the second UPF, the received first data packet to the second UE.

2. The method according to claim 1, wherein the method further comprises:
when the first data packet is sent to the first UPF by the first UE, sending, by the first SMF, a first N4 signaling to the first UPF and the first group communication UPF to make the first UPF and the first group communication UPF establish, based on the received first N4 signaling, a second communication tunnel; and
when receiving the first data packet sent by the first UE, forwarding, by the first UPF, the first data packet to the first group communication UPF according to the first forwarding rule issued by the first SMF comprises:
receiving, by the first UPF, the first forwarding rule issued by the first SMF; and
when receiving the first data packet sent by the first UE, forwarding, by the first UPF, according to the first forwarding rule, the first data packet to the first group communication UPF using the second communication tunnel.

3. The method according to claim 1, wherein the method further comprises:
when the first data packet is received by the second group communication UPF, sending, by the second SMF, a second N4 signaling to the second group communication UPF and the second UPF according to the destination address in the first data packet to make the second group communication UPF and the second UPF establish, based on the received second N4 signaling, a third communication tunnel; and
forwarding, by the second group communication UPF, the received first data packet to the second UPF according to the second forwarding rule issued by the second SMF comprises:
receiving, by the second group communication UPF, the second forwarding rule issued by the second SMF; and
forwarding, by the second group communication UPF, according to the second forwarding rule, the received first data packet to the second UPF using the third communication tunnel.

4. The method according to claim 1, wherein sending, by the first group communication UPF, according to the destination address in the received first data packet, the first data packet to the second group communication UPF using the first communication tunnel comprises:
based on a forwarding table between individual group communication UPFs, sending, by the first group communication UPF, according to the destination address in the received first data packet, the first data packet to the second group communication UPF using the first communication tunnel; and
the method further comprises:
in a case where a third SMF is newly added to the virtual network group, selecting, by the third SMF, a UPF from UPFs managed by itself as a third group communication UPF; and
the method further comprises:
when configuration of a fourth communication tunnel configured between the third group communication UPF and the first group communication UPF and a fourth communication tunnel configured between the third group communication UPF and the second group communication UPF is completed, updating, by the third SMF, the forwarding table based on fourth communication tunnels.

5. A method for transmitting a data packet, applied to a virtual network group, comprising:
providing or accessing the virtual network group, wherein the virtual network group comprises a first Session Management Function (SMF) and a second SMF, a first group communication User Plane Function (UPF) managed by the first SMF, and a second group communication UPF managed by the second SMF, wherein a first communication tunnel is pre-configured between the first group communication UPF and the second group communication UPF, the first group communication UPF is associated with a third User Equipment (UE), and the second group communication UPF is associated with a fourth UE;
when receiving a second data packet sent by the third UE, sending, by the first group communication UPF, according to a destination address in the received second data packet, the second data packet to the second group communication UPF using the first communication tunnel; and
sending, by the second group communication UPF, the received second data packet to the fourth UE.

6. A virtual network group, comprising:
a first Session Management Function (SMF) and a second SMF, a first User Plane Function (UPF) and a first group communication UPF managed by the first SMF, and a second UPF and a second group communication UPF managed by the second SMF;
a first communication tunnel is pre-configured between the first group communication UPF and the second group communication UPF, wherein the first UPF is associated with a first User Equipment (UE), and the second UPF is associated with a second UE, wherein:
the first UE is configured to send a first data packet to the first UPF;
the first UPF is configured to, when receiving the first data packet sent by the first UE, forward the first data packet to the first group communication UPF according to a first forwarding rule issued by the first SMF;
the first group communication UPF is configured to send, according to a destination address in the received first data packet, the first data packet to the second group communication UPF using the first communication tunnel;
the second group communication UPF is configured to forward the received first data packet to the second UPF according to a second forwarding rule issued by the second SMF;
the second UPF is configured to send the received first data packet to the second UE; and
the second UE is configured to receive the first data packet.

7. The virtual network group according to claim 6, wherein the first SMF is further configured to, when the first data packet is sent to the first UPF by the first UE, send a first N4 signaling to the first UPF and the first group communication UPF to make the first UPF and the first group communication UPF establish, based on the received first N4 signaling, a second communication tunnel; and
the first UPF is further configured to receive the first forwarding rule issued by the first SMF; and when receiving the first data packet sent by the first UE, forward, according to the first forwarding rule, the first data packet to the first group communication UPF using the second communication tunnel.

8. The virtual network group according to claim 6, wherein the second SMF is further configured to, when the first data packet is received by the second group communication UPF, send a second N4 signaling to the second group communication UPF and the second UPF according to the destination address in the first data packet to make the second group communication UPF and the second UPF establish, based on the received second N4 signaling, a third communication tunnel; and
the second group communication UPF is further configured to receive the second forwarding rule issued by the second SMF; and forward, according to the second forwarding rule, the received first data packet to the second UPF using the third communication tunnel.

9. The virtual network group according to claim 6, wherein the first group communication UPF is further configured to, based on a forwarding table between individual group communication UPFs, send, according to the destination address in the received first data packet, the first data packet to the second group communication UPF using the first communication tunnel;
the virtual network group further comprises a newly added third SMF;
the third SMF is configured to select a UPF from UPFs managed by itself as a third group communication UPF; and
the third SMF is further configured to, when configuration of a fourth communication tunnel configured between the third group communication UPF and the first group communication UPF and a fourth communication tunnel configured between the third group communication UPF and the second group communication UPF is completed, update the forwarding table based on fourth communication tunnels.

10. A virtual network group, configured perform the method for transmitting the data packet according to claim 5.

11. An electronic device, comprising:
at least one hardware processor, a communication interface, a memory, and a communication bus, wherein the at least one hardware processor, the communication interface, and the memory communicate with each other through the communication bus; the memory has a computer program stored thereon; and the at least one hardware processor is configured to, when executing the computer program stored in the memory, implement the method for transmitting the data packet according to claim 1.

12. An electronic device, comprising:
at least one hardware processor, a communication interface, a memory, and a communication bus, wherein the at least one hardware processor, the communication interface, and the memory communicate with each other through the communication bus; the memory has a computer program stored thereon; and the at least one hardware processor is configured to, when executing the computer program stored in the memory, implement the method for transmitting the data packet according to claim 5.

13. A non-transitory computer-readable storage medium having a computer program stored thereon, which, when executed by at least one hardware processor, implements the method for transmitting the data packet according to claim 1.

14. A non-transitory computer-readable storage medium having a computer program stored thereon, which, when executed by at least one hardware processor, implements the method for transmitting the data packet according to claim 5.

15. A computer program product stored on a tangible medium comprising instructions which, when running on a computer having at least one hardware processor, cause the computer to perform the method for transmitting the data packet according to claim 1.

16. A computer program product stored on a tangible medium comprising instructions which, when running on a computer having at least one hardware processor, cause the computer to perform the method for transmitting the data packet according to claim 5.
